(19) United States
(12) Patent Application Publication
(10) Pub. No.: US 2026/0299690 A1
(43) Pub. Date: Oct. 1, 2026

(54) INFORMATION PROCESSING APPARATUS, INFORMATION PROCESSING METHOD, AND PROGRAM

(71) Applicant: Sony Group Corporation, Tokyo (JP)

(72) Inventors: Yuri ISHIKAWA, Kanagawa (JP); Hiroshi SUZUKI, Kanagawa (JP); Ryo YOKOYAMA, Tokyo (JP); Yusuke NAKAGAWA, Kanagawa (JP)

(21) Appl. No.: 18/996,284

(22) PCT Filed: Jun. 8, 2023
(86) PCT No.: PCT/JP2023/021283

§ 371 Date: Jan. 17, 2025

(30) Foreign Application Priority Data
Aug. 24, 2022 (JP) 2022-133242

(51) Int. Cl. G06F 3/01; B25J 13/02; G06F 3/0346

(52) U.S. Cl. CPC G06F 3/016; B25J 13/025; G06F 3/014; G06F 3/017; G06F 3/0346

(57) ABSTRACT

Provided an example information processing method including determining a plurality of states of an operation object in relation to a target object in a virtual space, the states including a first state in which the operation object takes a first action on the target object, a second state in which the operating object maintains the first action on the target object, the second state occurring after the first state, and a third state prior to the first state; determining distances between the operation object and the target object in the virtual space in the third state, the determined distances including a first distance and a second distance less than the first distance; transitioning from the third state to the first state responsive to determining the second distance; transitioning from the first to second state; and generating haptic sensation signals corresponding to each of the first, second, and third states.

### CROSS REFERENCE TO RELATED APPLICATIONS

This application claims the benefit of Japanese Priority Patent Application JP 2022-133242 filed Aug. 24, 2022, the entire contents of which are incorporated herein by reference.

### TECHNICAL FIELD

The present technology relates to an information processing apparatus, an information processing method, and a program that are applicable to haptic presentation and the like.

### BACKGROUND ART

Patent Literature 1 discloses a contact presentation apparatus that determines a po-sitional relationship between a position of a human body and a virtual object, stimulates the human body with first intensity when the human body and the virtual object are not in contact with each other, and stimulates the human body with second intensity stronger than the first intensity when the human body and the virtual object are in contact with each other. This allows to stimulate a user without causing the user to feel discomfort (see paragraphs 0034 to 0047 of the specification, FIG. 2, and the like of Patent Literature 1).

### CITATION LIST

### Patent Literature

PTL 1: Japanese Patent Application Laid-open No. 2008-123431

### SUMMARY

### Technical Problem

In such a haptic presentation to a user, there is a desire for a technology capable of improving usability.

In view of the circumstances as described above, it is an object of the present technology to provide an information processing apparatus, an information processing method, and a program that are capable of improving usability.

### Solution to Problem

In order to achieve the above-mentioned object, an information processing apparatus according to an embodiment of the present technology includes a processor in communication with a tracking device, a video display, and a haptic device.

For example, an information processing apparatus includes at least one processor configured to:
determine a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determine distances between the operation object and the target object in the virtual space in the third state, the determined distances including a first distance and a second distance which is less than the first distance;
transition from the third state to the first state in response to determining the second distance;
transition from the first state to the second state; and
generate haptic sensation signals corresponding to each of the first state, the second state, and the third state.

In an example, a system includes the information processing apparatus and a tracking device, a video display, and/or a haptic device. The information processing apparatus may include a memory communicatively coupled to the processor.

As a result, the information processing apparatus makes it possible to improve usability of the system and, particularly, improve the usability of the haptic device.

The first action may include an action in which the operation object touches or holds the target object, or the first action may be another other specific action.

In an example, a system comprises:
the information processing apparatus discussed above;
a tracking device configured to track movement of a user;
a video display configured to display the target object and the operation object in the virtual space; and
a haptic device to present the haptic sensations based on the haptic sensation signal for each of the plurality of states.

In an example, the system further includes a glove, which includes the tracking device and the haptic device, and a head-mounted display which includes the video display.

In various example embodiments, the information processing apparatus and/or the system may perform any one or more of the following methods or processes.

In an example, an information processing method includes:
determining a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determining distances between the operation object and the target object in the virtual space in the third state, the determined distances including a first distance and a second distance which is less than the first distance;
transitioning from the third state to the first state in response to determining the second distance;
transitioning from the first state to the second state; and
generating haptic sensation signals corresponding to each of the first state, the second state, and the third state.

In an example, the method further includes:
transitioning from the second state to the fourth state; and
generating a haptic sensation signal corresponding to the fourth state.

In an example, haptic sensations change at each transition between states.

In an example, the operation object is a finger, a hand or a glove.

In an example, the first action of the first state is touching the target object.

In an example, the operating object holds the target object during the second state.

In an example, the operating object approaches the target object in the third state.

In an example, the operating object releases the target object at the fourth state.

In an example, the third state is entered when the operation object is at a third distance which is a threshold, the third distance being equal or greater than the first distance.

In an example, the second distance is zero or negative.

In an example, at least one of the third state or the fourth state is triggered by a gesture.

In an example, the gesture includes a finger bending.

In an example, the first distance varies based on a size of the target object.

In an example, a weight of the target object corresponds to a magnitude or an amount of a haptic sensation of the second state.

In an example, the method further includes, when the operation object takes the first action on the target object, adding to at least one of the target object or the operation object an effect of at least one of light emission, blinking, and a color change.

In an example, the method further includes presenting haptic sensations of the operation object and second haptic sensations of a second operation object in opposite directions.

In an example, the target object represents a real object, and the virtual space is presented to a user controlling a robot in a real space which includes the real object.

In an example, haptic sensations caused by the haptic sensation signals include a pressure and at least one of a vibration or a temperature change.

In an example, the operation object takes a second action, which is a different type of action than the first action.

In an example, the operation object takes a second action, which is repeating the first action again.

In an example, a program is stored on a computer readable medium, which when executed by a processor, causes the processor to execute any one of the above discussed methods or processes, or execute in or with any of the components of the system.

In an example, a program stored on a computer readable medium, which when executed by a processor, causes the processor to:
determine a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determine distances between the operation object and the target object in the virtual space in the third state, the determined distances including a first distance and a second distance which is less than the first distance;
transition from the third state to the first state in response to determining the second distance;
transition from the first state to the second state; and
generate haptic sensation signal corresponding to each of the first state, the second state, and the third state.

### BRIEF DESCRIPTION OF DRAWINGS

FIG. 1 is a diagram showing an overview of haptic sensation feedback.

FIG. 2 is a block diagram showing a configuration example of a haptic presentation system.

FIG. 3 is a flowchart showing generation of haptic sensation data.

FIG. 4 are a diagram schematically showing an example of generating haptic sensation data on the basis of a threshold value 1 and a threshold value 2.

FIG. 5 is a flowchart of another example showing generation of haptic sensation data.

FIG. 6 are each a diagram schematically showing an example of generating haptic sensation data in a region.

FIG. 7 is a flowchart of another example showing generation of haptic sensation data.

FIG. 8 are each a diagram schematically showing an example of generating haptic sensation data in speed of an operation object.

FIG. 9 are each a diagram showing an Example of hold control.

FIG. 10 are each a schematic diagram showing an example of controlling holding control.

FIG. 11 is a diagram showing an Example in which the operation object is not a hand.

FIG. 12 is a diagram showing an Example in which the operation object is not a hand.

### DESCRIPTION OF EMBODIMENTS

Hereinafter, an embodiment according to the present technology will be described with reference to the drawings.

### Presentation Control of Haptic Sensation Feedback

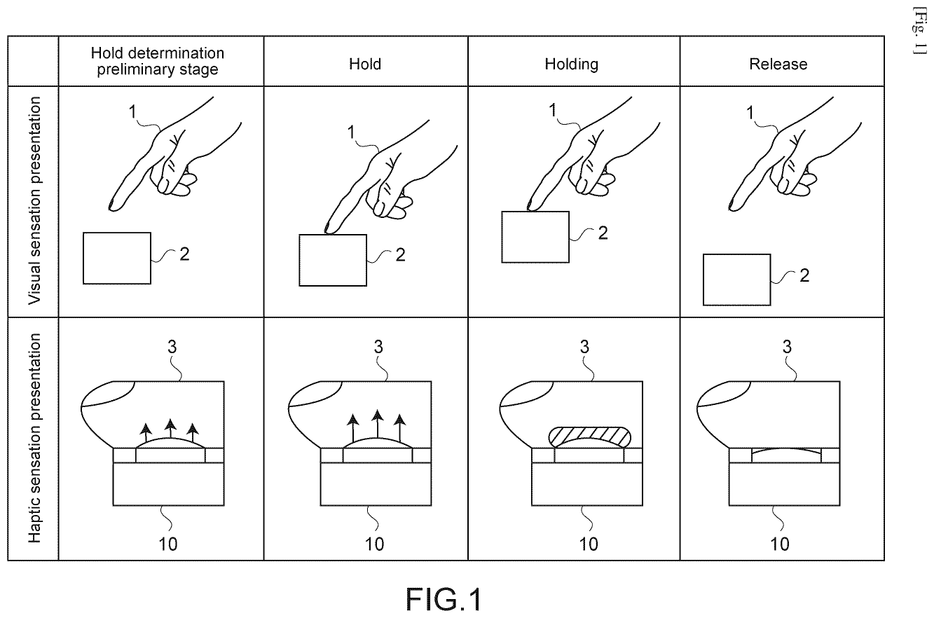

FIG. 1 is a diagram showing an overview of haptic sensation feedback according to an embodiment of the present technology.

As shown in FIG. 1, when an operation object 1 (band) operated by a user 3 takes a specific action on a target object 2, a haptic sensation feedback device 10 worn by the user 3 presents a haptic sensation.

In this embodiment, the haptic sensation feedback device 10 is worn by a finger of the user 3. That is, by presenting a haptic sensation such as compression to a finger of the user 3, feedback regarding whether or not the operation object 1 is successfully taking a specific action on the target object 2 is presented.

Note that although a device worn by one finger of the user 3 is illustrated in FIG. 1 as the haptic sensation feedback device 10, the present technology is not limited thereto and a device worn by two or more fingers may be used. Further, the haptic sensation to be presented by the haptic sensation feedback device 10 is not limited to compression and may be vibration or a temperature change. Alternatively, sound, light, or the like other than the haptic sensation may be presented to the user.

The specific action includes holding or touching. The holding in this embodiment includes the following of the target object 2 in accordance with the movement of the operation object 1. Examples of the holding include, in the case where the operation object 1 is a band, gripping the target object 2 with the palm and moving the target object 2 and the movement of the target object 2 in accordance with the movement of the tip of the finger of the operation object 1.

In addition, in the case where a laser pointer is an operation object, the holding may include that a target object continues to be irradiated with a laser beam and the target object moves in accordance with the orientation and movement of the laser point (movement of the point to which the laser beam is applied). That is, when the target object follows, the target object may be in contact with the operation object or apart from the operation object.

As shown in FIG. 1, four states are set for the specific action taken by the operation object 1. In this embodiment, four states of hold determination preliminary stage, touch or hold, holding, and release are set as the specific action with holding as an example. Further, the haptic sensation feedback device 10 presents, to a user, a different haptic sensation for each of the hold determination preliminary stage, hold, and holding states.

The hold determination preliminary stage represents a state in which the operation object 1 is almost capable of holding the target object 2. For example, in the case where the operation object 1 is located within a predetermined distance from the target object 2, it is determined as the hold determination preliminary stage. That is, the hold determination preliminary stage is a state before transitioning to the “hold” state, and when a haptic sensation is presented by the haptic sensation feedback device 10 when entering the hold determination preliminary stage, the user 3 can understand that the target object 2 is a holdable object.

Note that the condition to be determined as the hold determination preliminary stage is not limited to the distance, and various conditions such as the time and a case where a predetermined operation has been performed within a predetermined distance may be combined. For example, in the case where the operation object 1 needs to be in contact with the target object 2 and it is necessary to press a button of a controller for five seconds when holding the target object 2, the time period from three seconds to five seconds may be determined as the hold determination preliminary stage.

The hold is a state of the moment when the operation object 1 came into contact with the target object 2. In this embodiment, in the stage of the hold, the haptic sensation feedback device 10 presents a haptic sensation stronger than the haptic sensation presented in the hold determination preliminary stage. Further, the “hold” state in this embodiment represents the moment of hold. Typically, the “hold” state represents the moment when the operation object 1 came into contact with the target object 2. Note that the haptic sensation presented in the hold is not limited and may be arbitrarily set. For example, a haptic sensation equivalent to or weaker than the haptic sensation presented in the hold determination preliminary stage may be presented. Further, for example, a haptic sensation may be momentarily presented in the hold determination preliminary stage and a haptic sensation of the same intensity may be momentarily presented in the hold.

The holding is a state in which the operation object 1 continues the hold on the target object 2. In this state, the haptic sensation feedback device 10 presents a haptic sensation indicating that the hold continues. For example, during the holding, compression is constantly presented. Note that the haptic sensation presented during the holding may constantly be of the same intensity and may vary depending on the operation of the operation object during the holding.

As a result, since the intensity of the presented haptic sensation differs, it is easy to recognize the change in each state and the current state. However, a haptic sensation of the same intensity may be presented in the case where the performance of the device is limited, e.g., the haptic sensation that can be presented by the haptic sensation feedback device 10 has only two types of intensity, weak and strong.

Note that the intensity of the haptic sensation is not limited and may be arbitrarily set. For example, the intensity of the haptic sensation may be set on the basis of a dis-crimination threshold in the haptic sensation of a user or may be manually set by a user.

The release is a state in which the operation object 1 does not hold the target object 2. In this state, haptic presentation from the haptic sensation feedback device 10 is not performed. Note that a haptic sensation may be presented at the moment of entering the release state, i.e., the moment when the operation object 1 released the target object 2.

Note that the four states described above are examples in the case where the specific action is holding. That is, in the case where the specific action is not holding, the four states described above can be rephrased as a first state, a second state, a third state, and a fourth state, the first state being a state of a moment when the operation object took a specific action on the target object, the second state being a state in which the operation object continues the specific action on the target object, the third state being a state before transitioning to the first state, the fourth state being a state in which the specific action is not taken.

For example, in the case where pressing a button (target object) is the specific action, the state in which the operation object has approached the button corresponds to the third state. Further, the moment when the operation object became contact with the button corresponds to the first state and the state of pressing and holding the button corresponds to the second state.

In addition, in the case where the operation object is flare and the specific action is burning the target object, the state in which the flare has approached the target object corresponds to the third state. Further, the moment when the flare came into contact with the target object corresponds to the first state and the state of keeping burning corresponds to the second state.

As described above, by setting a third state that is a preliminary stage for various specific actions, a user can clearly understand whether or not the specific action is being successfully taken.

In this embodiment, one of the four states described above is determined on the basis of object information including information regarding a position of an operation object and target object information including information regarding a position of a target object.

The operation object 1 includes a hand, a robot arm, or the like displayed in a virtual space. For example, the operation object 1 may be operated by tracking the movement of the haptic sensation feedback device 10 worn by the user 3 (movement of the user) or the user 3 may operate the operation object 1 by operating a controller on which the haptic sensation feedback device 10 has been mounted.

The object information includes position information, action information, and speed information of the operation object 1. The action information includes an action different from the specific action, such as making a gesture such as bending a hand and bend a finger in the case where the operation object 1 is a hand and rotating an arm by 360 degrees in the case where the operation object 1 is a robot arm.

The target object 2 includes a virtual object displayed in a virtual space, a real object, and the like. In this embodiment, target object information of the target object 2 includes position information and a physical parameter of the target object. For example, the physical parameter includes various parameters such as the size, shape, weight, hardness, viscosity, position of the centroid, or temperature of the target object. Note that the position information may be coordinates relative to the operation object 1 or absolute coordinates.

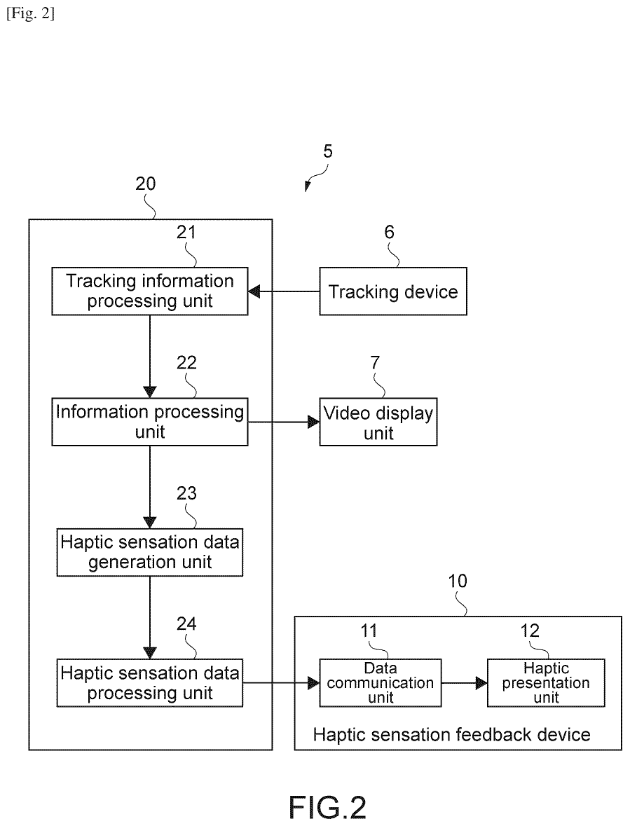

FIG. 2 is a block diagram showing a configuration example of a haptic presentation system 5.

As shown in FIG. 2, the haptic presentation system 5 includes a tracking device 6, a video display unit 7, the haptic sensation feedback device 10, and an information processing apparatus 20.

The tracking device 6 tracks the movement of a user. The tracking device 6 includes a sensor and a camera for detecting the movement of the user, and the inside-out method or the outside-in method is used.

The video display unit 7 is a device that displays an operation object and a target object for a user. For example, a mobile terminal such as a smartphone, a head-mounted display (HMD), optical see-through augmented reality (AR), or the like may be used. In this embodiment, a user can visually recognize a target object and an operation object via the video display unit 7. Further, the operation object may be checked with the naked eye of the user.

The haptic sensation feedback device 10 includes a data communication unit 11 and a haptic presentation unit 12. The data communication unit 11 receives haptic sensation data transmitted by the haptic sensation data processing unit 24 of the information processing apparatus 20 and supplies the received haptic sensation data to the haptic presentation unit 12. The haptic presentation unit 12 presents, on the basis of the haptic sensation data, a haptic sensation suitable for the user. Note that the method of presenting a haptic sensation to a user by the haptic presentation unit 12 is not limited. An air pressure may be used to present a pressure sensation or a cooling device may be used to present a temperature change.

Note that the haptic sensation feedback device 10 is not limited, and an arbitrary device such as a mouse, a controller, a sensor glove worn by a hand of the user, and a smartphone that can vibrate may be used.

The information processing apparatus 20 includes a tracking information processing unit 21, an information processing unit 22, a haptic sensation data generation unit 23, and a haptic sensation data processing unit 24.

The tracking information processing unit 21 receives, as tracking information, information regarding the movement of the user's hand (finger), the movement of the user's eye, the movement of the user's head, or the direction of the user's gaze tracked by the tracking device 6.

The information processing unit 22 determines, on the basis of the target object information and the object information, which of the four states described above the state of the operation object 1 and the target object 2 is. In this embodiment, the information processing unit 22 determines one of the hold determination preliminary stage, hold, holding, and release on the basis of the position information of the operation object 1 and the position information of the target object 2.

Further, the information processing unit 22 outputs visual information in the specific action to the video display unit 7. For example, in the case where the operation object holds the target object, it is possible to visually recognize how the target object follows in accordance with the movement of the operation object. In addition, when an operation object takes a specific action on a target object, an effect such as light emission, blinking, and a color change may be added to the target object and the operation object.

The haptic sensation data generation unit 23 generates haptic sensation data to be presented to a user. In this embodiment, the haptic sensation data generation unit 23 generates haptic sensation data on the basis of the four states of the hold determination preliminary stage, hold, holding, and release, the target object information, and the object information. For example, in the case where an operation object holds a heavy target object, haptic sensation data for presenting a haptic sensation stronger than that of the case of holding a light target object is generated.

The haptic sensation data processing unit 24 outputs, to the haptic sensation feedback device 10, the haptic sensation data generated by the haptic sensation data generation unit 23. Note that the haptic sensation data to be output may be changed by the haptic sensation data processing unit 24 depending on the haptic sensation feedback that can be presented by the haptic sensation feedback device 10. For example, in the case where haptic sensation data for presenting, to a user, a pressure sensation when holding a hard object and a haptic sensation (temperature change) when holding a hot object is generated and the haptic sensation feedback device 10 is a device capable of presenting only a pressure sensation, the haptic sensation data may be changed to one excluding the temperature change of the haptic sensation data described above.

In an example embodiment, a structure of the devices of haptic presentation system 5 may differ from the system illustrated in FIG. 2. For example, rather than an information processing apparatus 20 including a tracking information processing unit 21, an information processing unit 22, a haptic sensation data generation unit 23, and a haptic sensation data processing unit 24, and the haptic sensation feedback device 10 including the data communication unit 11 and the haptic presentation unit 12. The present disclosure is not limited by the illustrated structure, as would be understood by those skilled in the art. In an example embodiment (not illustrated), the haptic sensation data generation unit 23 and the haptic sensation data processing unit 24 may be located in the haptic sensation feedback device 10 along with the data communication unit 11 and the haptic presentation unit 12, while the tracking information processing unit 21 and the information processing unit 22 may be located in the information processing apparatus 20. Various other structures with components in one or more separate physical devices may be implemented, or a single physical device may in some cases include all of the components described above, and may also in some cases include a tracking device 6 and/or a video display unit 7, for example, in a fully integrated system.

Note that in this embodiment, the information processing unit 22 corresponds to a determination unit that determines, on the basis of object information including information regarding a position of an operation object and target object information including information regarding a position of a target object, a first state, a second state, and a third state, the first state being a state of a moment when the operation object took a specific action on the target object, the second state being a state in which the operation object continues the specific action on the target object, the third state being a state before transitioning to the first state.

Note that in this embodiment, the haptic sensation data generation unit 23 and the haptic sensation data processing unit 24 function as a presentation unit that presents, on the basis of a result of the determination, haptic sensation feedback to a user who operates the operation object.

Note that in this embodiment, the hold corresponds to a first state, the first state being a state of a moment when the operation object took a specific action on the target object.

Note that in this embodiment, the holding corresponds to a second state, the second state being a state in which the operation object continues the specific action on the target object.

Note that in this embodiment, the hold determination preliminary stage corresponds to a third state, the third state being a state before transitioning to the first state.

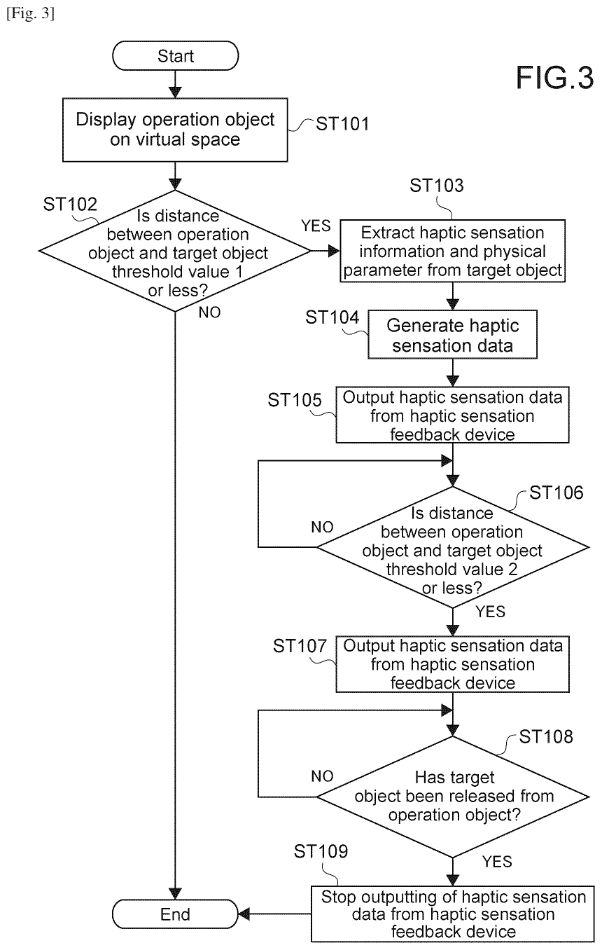

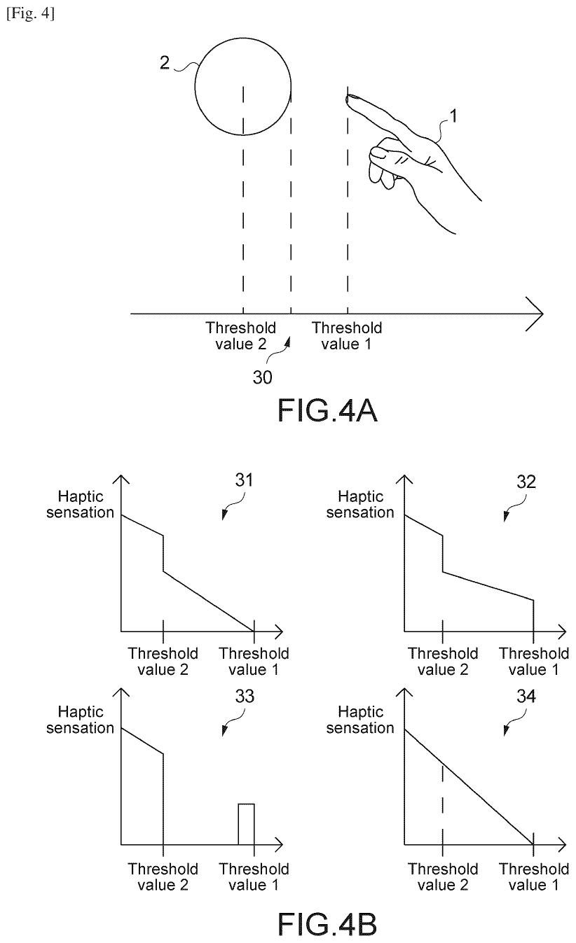

FIG. 3 is a flowchart showing generation of haptic sensation data. FIG. 4 are each a diagram schematically showing an example of generating haptic sensation data on the basis of a threshold value 1 and a threshold value 2.

In FIG. 3, assumption is made that a user takes a specific action on a target object (virtual object) present on a virtual space such as AR and virtual reality (VR).

The tracking device 6 performs tracking and the operation object operated by a user is displayed on a virtual space (Step 101). In this embodiment, the displayed operation object 1 approaches the target object 2 to hold the target object 2.

The information processing unit 22 determines whether or not the distance between the operation object 1 and the target object 2 is the threshold value 1 or less (Step 102).

As shown in FIG. 4A, the threshold value 1 and the threshold value 2 are set for the target object 2. In FIG. 4A, the surface of the target object 2 is used as a reference (distance=0), the threshold value 1 is larger than the threshold value 2, and the threshold value 2 is set such that the distance is zero or negative. Further, the threshold value 1 may be set such that the distance is zero or more.

Note that the threshold value 1 and the threshold value 2 may each be a fixed value and may vary depending on parameters such as the size and shape of the target object 2 or parameters such as the size and shape of the operation object 1.

In the case where the distance between the operation object and the target object is the threshold value 1 or less (YES in Step 102), the information processing unit 22 extracts haptic sensation information and a physical parameter from the target object (Step 103).

The haptic sensation information is information regarding a haptic sensation corresponding to a target object. For example, a pressure sensation(haptic sensation information) is set in accordance with the hardness of a target object. In the case where a target object is soft, a pressure sensation is set such that a sensation of an operation object sinking into the target object is presented to a user. In addition, various haptic sensations are set in accordance with physical parameters such as the temperature and weight of a target object. Further, in the case where a light target object and a heavy target object are held, a haptic sensation when holding the heavy target object is presented to be stronger.

The haptic sensation data generation unit 23 generates haptic sensation data based on the haptic sensation information and the physical parameter (Step 104). The haptic sensation data processing unit 24 supplies the generated haptic sensation data to the haptic sensation feedback device 10, and the haptic sensation feedback device 10 outputs the haptic sensation data (Step 105). As a result, the user can recognize a haptic sensation in the hold determination preliminary stage.

The information processing unit 22 determines whether or not the distance between the operation object 1 and the target object 2 is the threshold value 2 or less (Step 106).

In the case where the distance between the operation object 1 and the target object 2 is the threshold value 2 or less (YES in Step 106), the haptic sensation feedback device 10 outputs haptic sensation data (Step 107). As a result, the user can recognize a haptic sensation in the hold.

In FIG. 4B, the vertical axis indicates the intensity of a haptic sensation to be presented (e.g., a pressure) and the horizontal axis indicates the distance of an operation object. As shown in FIG. 4A, the operation object 1 approaches the target object 2 in the direction opposite to the horizontal direction.

In this embodiment, in the case where the operation object 1 is located between the threshold value 1 and the threshold value 2, the hold determination preliminary stage is determined. Further, in the case where the operation object 1 is located at the threshold value 2 or less, the hold is determined. In this case, as shown in FIG. 4B, the haptic sensation data generation unit 23 generates haptic sensation data to be presented to a user in a region between the threshold value 1 and the threshold value 2 (region 30) that is the hold determination preliminary stage.

For example, in a graph 31, a pressure to be presented increases as the operation object 1 is closer to the target object 2. Further, in the case where the operation object 1 has reached the threshold value 2, the hold is determined and the pressure momentarily increases. In the case where the operation object 1 is further closer to the threshold value 2 (the operation object 1 sinks into the target object 2), the holding is determined and a pressure to be presented further increases.

Further, for example, in a graph 32, when the operation object 1 has reached the threshold value 1 and the threshold value 2, a pressure momentarily increases.

Further, for example, in a graph 33, a pressure is presented only at the timing when the operation object 1 reached the threshold value 1. Further, no pressure is presented between the threshold value 1 and the threshold value 2, and a pressure is momentarily presented when the operation object 1 has reached the threshold value 2. In this case, when the operation object 1 has reached the threshold value 1, the state of the hold determination preliminary stage may be clearly indicated to a user by vibration, sound, or the like instead of a pressure. As a result, it is possible to reduce the power consumption of the haptic sensation feedback device 10.

Further, for example, in a graph 34, a pressure to be presented is stronger as the operation object 1 is closer to the target object 2. In this example, the hold determination preliminary stage is clearly indicated to the user by vibration, sound, or the like when the operation object 1 has reached the threshold value 1, and the hold is clearly indicated to the user by vibration, sound, or the like when the operation object 1 has reached the threshold value 2. That is, instead of a haptic sensation to be presented, the state of the hold determination preliminary stage or the hold may be presented to a user by another modal.

In addition to the examples described above, the state of the hold determination preliminary stage or the hold may be clearly indicated to a user by various changes in a pressure or presentation of a modal. Note that in order to clearly indicate the hold state to a user, a pressure desirably changes non-linearly at the threshold value 2.

The information processing unit 22 determines whether or not the target object has been released from the operation object (Step 108). For example, in the case where the operation object 1 is located at a distance of the threshold value 1 or more from the target object 2, the release may be determined. Further, for example, when the operation object 1 makes a predetermined gesture or the like, the release may be de-termined.

In the case where it is determined that the target object has been released from the operation object (YES in Step 108), the haptic sensation data processing unit 24 stops the outputting of haptic sensation data and the presentation of a haptic sensation from the haptic sensation feedback device 10 is stopped (Step 109).

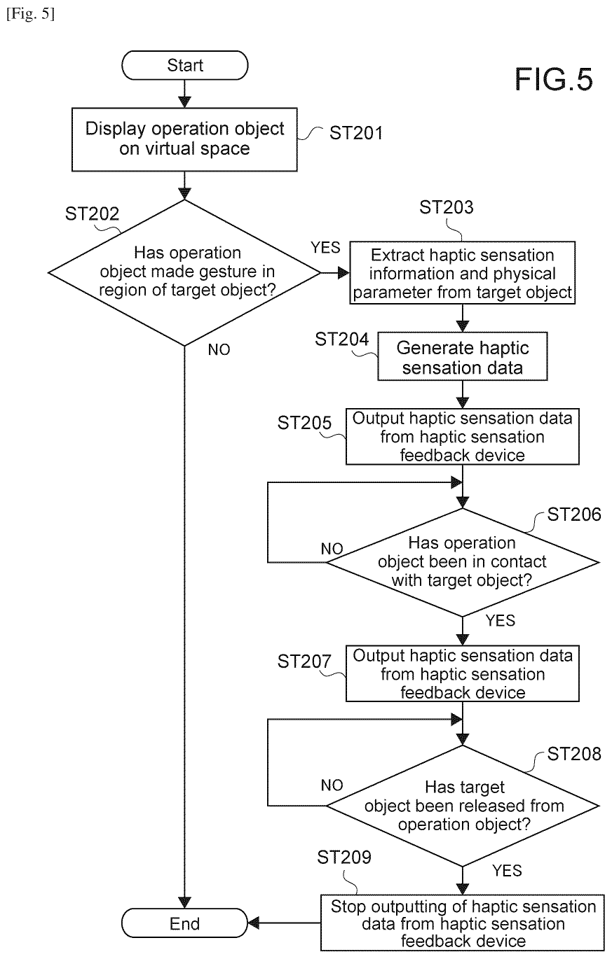

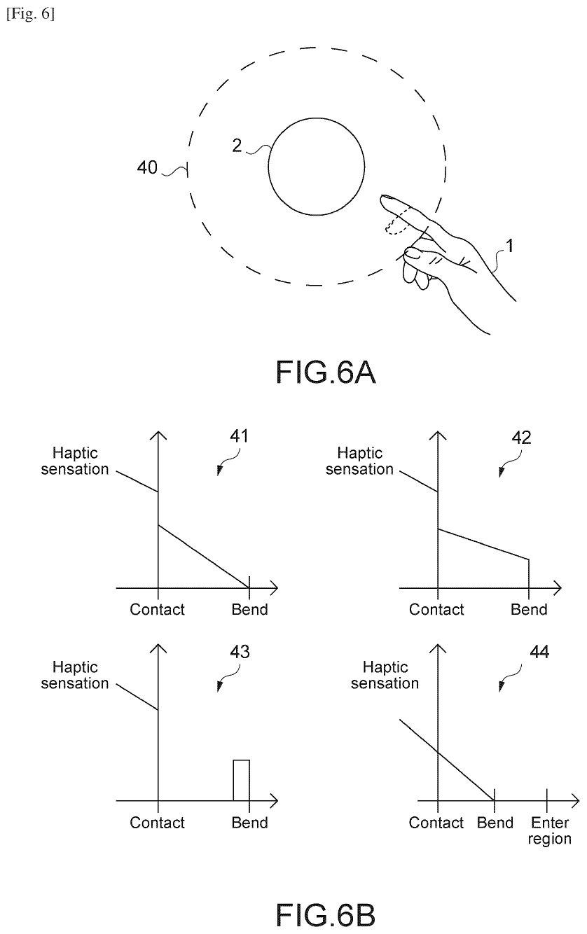

FIG. 5 is a flowchart of another example showing generation of haptic sensation data. FIG. 6 are each a diagram schematically showing an example of generating haptic sensation data in a region.

In FIG. 5, when the operation object 1 makes a gesture (action information) within a predetermined region 40 around the target object 2, the hold determination preliminary stage is determined (see FIG. 6A).

As shown in FIG. 5, the operation object operated by a user is tracked by the tracking device 6 and displayed on a virtual space (Step 201).

The information processing unit 22 determines whether or not the operation object has made a gesture in the region of the target object (Step 202). In this embodiment, as shown in FIG. 6A, when a gesture of bending a finger within the region 40 is made, the hold determination preliminary stage is determined.

In the case where an operation object makes a gesture within a region of a target object (YES in Step 202), the information processing unit 22 extracts haptic sensation information and a physical parameter from the target object (Step 203).

The haptic sensation data generation unit 23 generates haptic sensation data based on the haptic sensation information and the physical parameter (Step 204). The haptic sensation data processing unit 24 supplies the generated haptic sensation data to the haptic sensation feedback device 10, and the haptic sensation feedback device 10 outputs the haptic sensation data (Step 205). As a result, the user can recognize a haptic sensation in the hold determination preliminary stage.

The information processing unit 22 determines whether or not the operation object has been in contact with the target object (Step 206). Note that a gesture of an operation object only needs to be performed once within the region 40 and does not need to be continued. That is, after bending the finger once, the finger may be kept straight. Further, a gesture of releasing the hold determination preliminary stage may be set.

In the case where the operation object 1 and the target object 2 are in contact with each other (YES in Step 206), the haptic sensation feedback device 10 outputs haptic sensation data (Step 207). As a result, the user can recognize a haptic sensation in the hold.

In FIG. 6B, the vertical axis indicates the intensity of a haptic sensation to be presented and the horizontal axis indicates the distance of an operation object.

As shown in FIG. 6B, the haptic sensation data generation unit 23 determines the hold determination preliminary stage from the moment when a gesture of the operation object 1 within the region 40 was made to the moment of the contact. Further, the haptic sensation data generation unit 23 determines the moment when the operation object 1 came into contact with the target object 2 (distance=0) as the hold and determines the state in which an operation object sinks into a target object (distance<0) as the holding.

For example, in a graph 41, a pressure to be presented increases as the operation object 1 bends the finger and is closer to the target object 2. Further, in the case where the operation object 1 has come into contact with the target object 2, the hold is de-termined and a pressure momentarily increases. In the case where the operation object 1 is further closer to the threshold value 2 (the operation object 1 sinks into the target object 2), the holding is determined and a pressure to be presented further increases.

Further, for example, in a graph 42, when the operation object 1 bends the finger within the region 40, a pressure momentarily increases. Further, when the operation object 1 has come into contact with the target object 2, a pressure momentarily increases.

Further, for example, in a graph 43, a pressure is presented only at the timing when the operation object 1 bent the finger within the region 40. Further, no pressure is presented until the operation object 1 comes into contact with the target object 2, and a pressure is momentarily presented when the operation object 1 has come into contact with the target object 2.

Further, for example, in a graph 44, a pressure to be presented is stronger as the operation object 1 is closer to the target object 2. In this example, when the operation object 1 enters the region 40, a user is informed of that the operation object 1 has entered the region 40, by vibration, sound, or the like. Further, the hold determination preliminary stage is clearly indicated to the user by presentation of a pressure in addition to vibration or sound when the finger is bent within the region 40, and the hold is clearly indicated to the user by vibration, sound, or the like when the operation object 1 has come into contact with the target object 2.

The information processing unit 22 determines whether or not the target object has been released from the operation object (Step 208). For example, in the case where the operation object 1 is located outside the region 40 from the target object 2, the release may be determined.

Further, when a gesture such as bending a finger is made during the hold or holding, a release determination preliminary stage that is a state before transitioning to the release may be determined. For example, in the release determination preliminary stage, a momentary pressure may be presented at the moment of transitioning to this state, similarly to the hold, or transitioning to the release determination preliminary stage may be clearly indicated by another modal using vibration, sound, or the like.

The method of transitioning from the release determination preliminary stage to the release is not limited, and the release determination preliminary stage may transition to the release when an operation object has moved to the outside of the region 40, the finger is bent again, or a gesture different from the gesture for transitioning to the release determination preliminary stage is made.

In the case where the release is determined (YES in Step 208), the haptic sensation data processing unit 24 stops the outputting of haptic sensation data and the presentation of a haptic sensation from the haptic sensation feedback device 10 is stopped (Step 209).

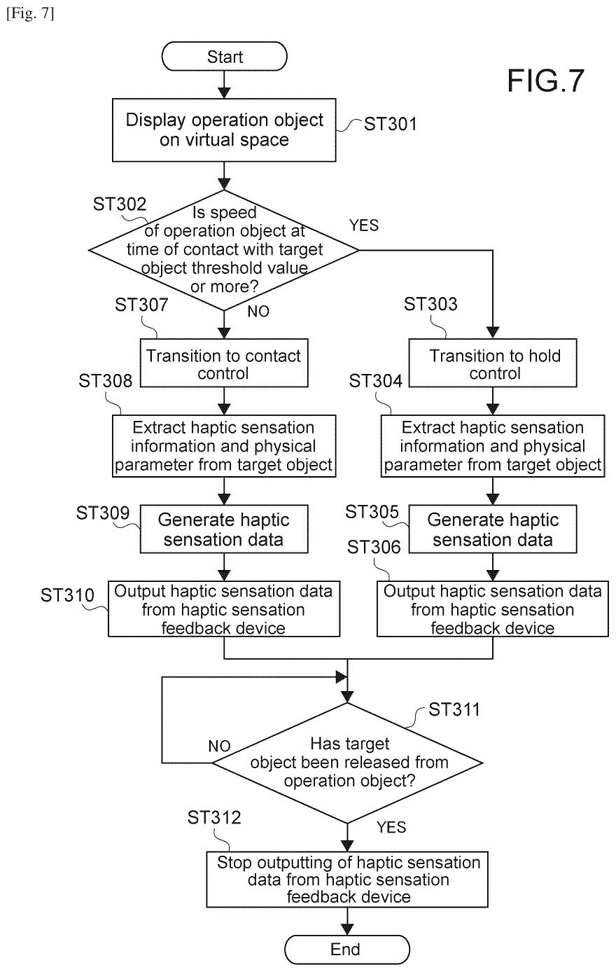

FIG. 7 is a flowchart of another example showing generation of haptic sensation data.

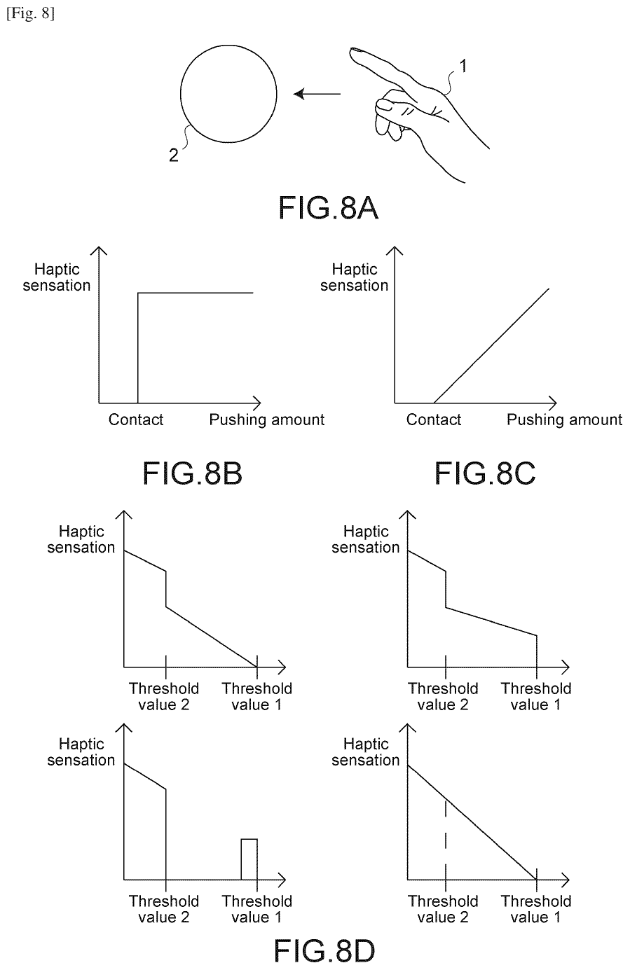

FIG. 7 is a flowchart of another example showing generation of haptic sensation data corresponding to the speed when the operation object 1 has come into contact with the target object 2. FIG. 8 are each a diagram schematically showing an example of generating haptic sensation data in speed of an operation object.

In FIG. 7, different control of the hold or contact is performed in accordance with the speed when the operation object 1 comes into contact with the target object 2.

As shown in FIG. 7, the tracking device 6 performs tracking and the operation object operated by a user is displayed on a virtual space (Step 301).

The information processing unit 22 determines whether or not the speed of the operation object at the time of contact with the target object is a threshold value or more (Step 302).

In the case where the speed at the time of contact is the threshold value or more (YES in Step 302), the information processing unit 22 determines it as the hold and haptic presentation in the hold is performed (Step 303). Hereinafter, the control of haptic presentation in the hold will be referred to as hold control. Similarly, the control of haptic presentation in the holding will be referred to as holding control, and the control of haptic presentation in the release will be referred to as release control.

The information processing unit 22 extracts haptic sensation information and a physical parameter at the time of hold control from a target object (Step 304).

The haptic sensation data generation unit 23 generates haptic sensation data based on the haptic sensation information and the physical parameter (Step 305). The haptic sensation data processing unit 24 supplies the generated haptic sensation data to the haptic sensation feedback device 10 and the haptic sensation feedback device 10 outputs the haptic sensation data (Step 306).

In FIG. 8B, the vertical axis indicates the intensity of a haptic sensation to be presented and the horizontal axis indicates the pushing amount of the operation object 1. The pushing amount indicates how much the operation object 1 pushes the target object 2. In the hold control, the pushing amount can be said to be the amount of the movement distance in which the target object 2 follows the operation object 1 with the initial position of the target object 2 as the origin.

As shown in FIG. 8B, a pressure is momentarily presented when the operation object 1 has come into contact with the target object 2. In this embodiment, a haptic sensation in the holding is constantly presented with a pressure to be presented at the time of contact being unchanged. This aims to clearly indicate, to a user, that the target object 2 follows the operation object 1. That is, since the operation object 1 moves together with the target object 2 while being in contact with the surface of the target object 2, the operation object 1 does not sink into the target object 2 no matter how much the operation object 1 pushes the target object 2.

In the case where the speed at the time of contact is a threshold value or less (NO in Step 302), the information processing unit 22 determines the contact and haptic presentation in the contact is performed (Step 307). Hereinafter, the control of haptic presentation in the contact will be referred to as contact control.

The information processing unit 22 extracts haptic sensation information and a physical parameter at the time of contact control from a target object (Step 308).

The haptic sensation data generation unit 23 generates haptic sensation data based on the haptic sensation information and the physical parameter (Step 309). The haptic sensation data processing unit 24 supplies the generated haptic sensation data to the haptic sensation feedback device 10 and the haptic sensation feedback device 10 outputs the haptic sensation data (Step 310).

In FIG. 8C, the vertical axis indicates the intensity of a haptic sensation to be presented and the horizontal axis indicates the pushing amount of the operation object 1. The pushing amount in the contact control represents a value that increases as the distance between the operation object 1 and the target object 2 decreases from zero with the surface of the target object 2 as the origin (distance=0).

As shown in FIG. 8C, a pressure is presented when the operation object 1 has come into contact with the target object 2, and the pressure increases in accordance with the pushing amount of the operation object. Note that the pressure to be presented may be arbitrarily set in accordance with the physical parameter of the target object. For example, in the case of a hard target object, the pressure may increase exponentially with respect to the pushing amount.

The information processing unit 22 determines whether or not the target object 2 has been released from the operation object 1 (Step 311). In the case where the release is determined (YES in Step 311), the haptic sensation data processing unit 24 stops the outputting of haptic sensation data and the presentation of a haptic sensation from the haptic sensation feedback device 10 is stopped (Step 312).

Note that the threshold value of the speed in contact may be arbitrarily set. For example, the threshold value may be set on the basis of the speed when a user operates an operation object. Further, in the case where a target object has a physical parameter such as being fragile, the threshold value may be set such that the state cannot transition to the hold control when the operation object has come into contact with the target object at the speed of the threshold value or more. Further, a real object is fragile, a haptic sensation indicating to stop the operation object or a warning to a user may be presented, in the case where the operation object 1 has approached at the speed of the threshold value or more.

Further, the method of determining the hold determination preliminary stage in FIG. 7 and FIG. 8 is not limited. For example, the hold determination preliminary stage may be determined in the case where the operation object 1 has come into contact with the target object 2 at the speed of the threshold value 1 or more. In this case, when the speed of the operation object 1 is below the threshold value 2 that is the threshold value 1 or less, the hold may be determined. Further, the threshold value 1 and the threshold value 2 may be set to be the same value such that the state immediately transitions to the hold omitting the hold determination preliminary stage.

Further, the threshold value 1 and the threshold value 2 may each be a fixed value and may vary depending on parameters such as the size and shape of the target object 2 or parameters such as the size and shape of the operation object 1.

Further, as the method of determining the hold determination preliminary stage, various conditions may be combined in addition to the determination with the speed only. For example, the hold determination preliminary stage may be determined in the case where the speed of the operation object 1 is a threshold value or more and the distance between the operation object 1 and the target object 2 is within a predetermined range. Further, for example, the hold determination preliminary stage may be determined in the case where the speed of the operation object 1 is a threshold value or more and a gesture has been made within a region set so as to cover the target object 2.

Further, FIG. 8D is a diagram showing an example of haptic sensation feedback in the case where the threshold value 1 and the threshold value 2 relating to the speed of the operation object 1 are set. In FIG. 8D, the vertical axis indicates the intensity of a haptic sensation to be presented (e.g., a pressure) and the horizontal axis indicates the speed of an operation object.

As shown in FIG. 8D, a haptic sensation is momentarily presented at the time of contact with the speed of the threshold value 1 so that a user can recognize the transition to the hold determination preliminary stage. Similarly, a haptic sensation indicating the hold is momentarily presented when the speed has been below the threshold value 2. Note that the method of presenting a haptic sensation is not limited, and a haptic sensation may be presented similarly to the graphs 31, 32, 33, and 34 described above. Typically, a haptic sensation for informing the transition only needs to be presented at the timing of the threshold value 1 and the threshold value 2, i.e., for each of the hold determination preliminary stage and the hold. It goes without saying that sound, light, or the like may be presented instead of a haptic sensation.

### Hold Control

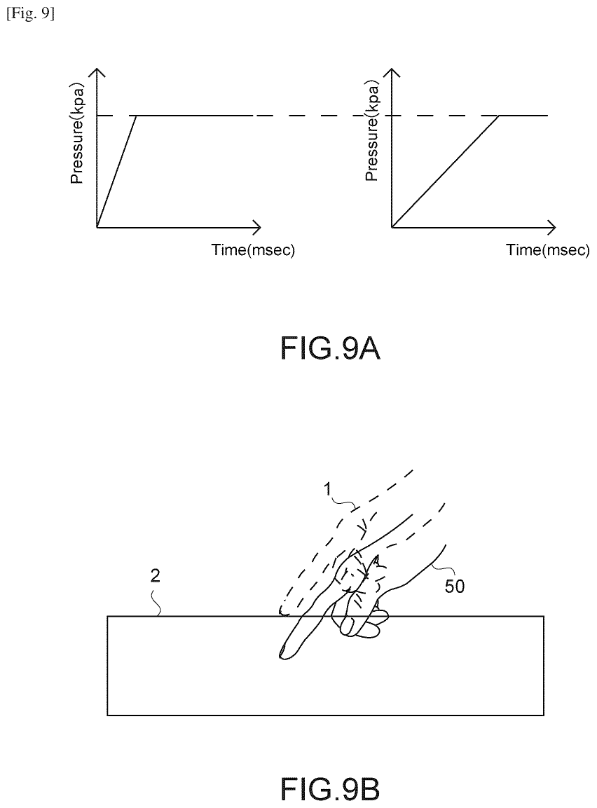

FIG. 9 are each a diagram showing an Example of hold control. FIG. 9A is a graph showing an example of control based on the speed at the moment when an operation object came into contact with a target object.

In the above, a haptic sensation has been presented in the hold, i.e., at the moment when an operation object came into contact with a target object. A specific control example of the hold control will be described below.

For example, as shown in FIG. 9A, the degree of fade-in of the pressure value may be controlled in accordance with the speed at the moment when an operation object came into contact with a target object. In FIG. 9A, the vertical axis indicates a pressure to be presented and the horizontal axis indicates the time until an operation object comes into contact with a target object.

The left graph of FIG. 9A shows a case where the speed of an operation object at the moment of contact is high, and the right graph of FIG. 9A shows a case where the speed of the operation object at the moment of contact is low. In the left graph, the time until the value of the final pressure to be presented is reached is set to be short in accordance with the speed of the operation object. Further, in the right graph, although the value of the final pressure is the same as that in the left graph, the speed of the operation object is lower than that in the left graph, and therefore, the time until the value of the final pressure is reached is prolonged.

In addition, in the case where an operation object has come into contact with a target object at the speed of a threshold value or more, the target object and a haptic sensation to be presented by the approaching (hold determination preliminary stage) and hold of the target object may be extinguished.

Further, in the case where an operation object has come into contact with a target object at the speed of a threshold value or less, i.e., an operation object has held a target object, haptic sensation feedback indicating the degree of the speed of an operation object may be presented.

Further, in the hold control, the distance and the arrival time until an operation object placed in a virtual space comes into contact with a target object may be calculated.

For example, the output timing may be shifted before contact such that a pressure sensation is presented at the accurate timing.

Further, for example, haptic sensation feedback may be controlled to be stronger as the distance an operation object and a target object decreases. As a result, it is possible to clearly indicate, to a user, that the operation object gradually approaches the target object.

Further, in the hold control, the intensity of haptic sensation feedback or the like may be changed depending on the physical parameter of the target object.

For example, the hardness of a target object may be presented using the intensity of compression. Further, for example, in the case where a target object is set to an adhesive material or a material that can fall off, strong haptic sensation feedback is presented first when an operation object has come into contact with a target object and the haptic sensation feedback may be controlled to be weaker over time. As a result, it is possible to present the adhesive sensation of the target object to a user.

FIG. 9B is a schematic diagram showing the degree of sinking of an operation object into a target object.

The degree of sinking represents the difference between the actual sensing position of a hand 50 of a user who operates an operation object and the visual display position of the operation object (the operation object 1). By calculating the degree of sinking, haptic sensation feedback may be controlled on the basis of the calculated degree of sinking.

Note that as the determination of the hold, a state other than the moment when an operation object has come into contact with a target object may be determined as the hold. For example, in the case where an operation object is a hand and the index finger is bent while the tip of the index finger is closer to a target object by a threshold value or more, the information processing unit 22 may determine that the user tries to hold the target object and the state may transition to the bold.

Note that the portion of an operation object that comes into contact with a target object for holding the target object is not limited. For example, a plurality of fingers, the back of hand, or the wrist may come into contact with the target object, or an object following the operation object may come into contact with the target object.

### Holding Control

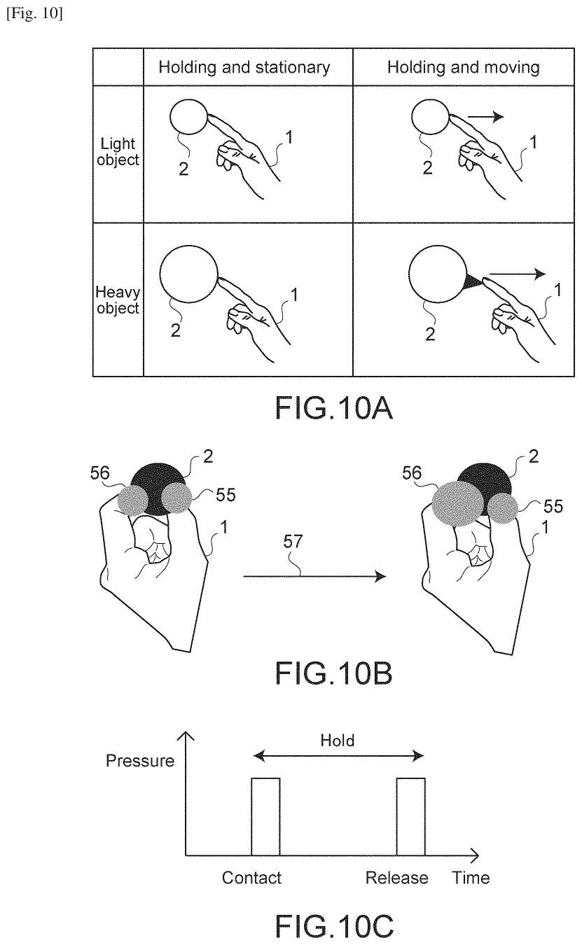

FIG. 10 are each a schematic diagram showing an example of controlling holding control. FIG. 10A, FIG. 10B, and FIG. 10C are each a diagram showing a specific control example of the holding control.

In FIG. 10A, in the holding, when the target object 2 follows in accordance with the movement of the operation object 1, the following delay is changed depending on the weight of the target object 2. By changing a pressure to be presented depending on the amount of the following delay, the weight and strength of inertial force of the target object 2 are presented to a user.

For example, as shown in FIG. 10A, assumption is made that a pressure of 5 kpa is presented to a user when holding the light target object 2. When this target object 2 is moved in the arrow direction, the target object 2 follows while being constantly in contact with the operation object 1 and inertial force (e.g., 5 kpa) according to the moving direction is presented to the user.

Further, for example, assumption is made that a pressure of 5 kpa is presented to a user when holding the heavy target object 2. When this target object 2 is moved in the arrow direction, the target object 2 follows the movement of the operation object 1 with delay. In this embodiment, the following delay represents that the target object 2 follows the movement of the operation object 1 while being apart from the operation object 1. Further, how much the following delay is caused, i.e., the degree of delay regarding how much distance, time, and the like the target object 2 is delayed with respect to the movement of the operation object 1, will be referred to as the following delay amount.

The following delay amount is set on the basis of the weight of the target object 2. In this embodiment, as a pressure to be presented to a user when a following delay is caused, a pressure (e.g., 8 kpa) stronger than the pressure presented in the hold is presented.

The following delay amount and the pressure to be presented when a following delay is caused may be arbitrarily set. For example, as the target object is heavier, the following delay may increase and the pressure to be presented may be largely changed. Further, for example, the following delay amount may be changed depending on the speed of the operation object.

FIG. 10B shows an example of holding control in the case where two or more haptic sensation feedback devices are worn by the tips of the fingers of a user. In the example shown in FIG. 10B, a haptic sensation feedback device is worn by the thumb and the index finger of a user and a haptic sensation is presented.

As shown in the left side of FIG. 10B, when the operation object 1 has held the target object 2, a haptic sensation is presented to a thumb 55 and an index finger 56. Further, as shown in the right side of FIG. 10B, in the case where the operation object 1 has moved in the direction indicated by an arrow 57, a stronger haptic sensation is presented from the haptic sensation feedback device worn by the index finger 56 in the direction opposite to the direction indicated by the arrow 57. As a result, a movement sensation, a weight sensation, the strength of inertial force, and the like are clearly indicated to the user.

In addition, in the case where a haptic sensation feedback device is worn by each of two or more fingers, the direction in which a sensation is presented may be changed depending on the tilt of the hand. As a result, a sensation as if a target object moves in an operation object is presented to the user.

In the example described above, a haptic sensation has been constantly presented in the holding control. The present technology is not limited thereto, and a haptic sensation may be presented only at the timing of holding a target object and releasing the target object. For example, as shown in FIG. 10C, a haptic sensation may be presented only for a predetermined time period from the moment when an operation object came into contact with a target object, and a haptic sensation may be presented only for a predetermined time period from the moment when the target object was released. As a result, it is possible to clearly present the contact of the operation object and the target object and reduce the power consumption during holding the target object.

Note that in the case where the intensity of a haptic sensation to be presented changes during the holding as in the holding control in the heavy target object shown in FIG. 10A or the example shown in FIG. 10B, a haptic sensation may be presented during the holding.

Further, in the case where the target object held in the holding control has collided with another object (virtual object or real object), a haptic sensation to be presented to the user may be changed. For example, a haptic sensation to be presented at the time of the collision may be presented to be strong. Further, in the case where the target object has collided with another object during the period in which no haptic sensation is presented as in the example shown in FIG. 10C, a haptic sensation may be presented at the moment of the collision.

### Release Control

A specific example regarding how a haptic sensation is presented to a user has been illustrated in the hold control and holding control described above. The following example of release control means how a haptic sensation to be presented to a user is stopped. That is, the control of haptic presentation includes presenting a haptic sensation to a user and stopping the presentation of a haptic sensation.

For example, assumption is made that information indicating that a target object is released at an arbitrary place is given and the target object is automatically released when a user moves the target object to that place. In this case, the haptic presentation to the user is stopped at the timing when the target object was released. That is, when transitioning to the “release” state, the transition to the “release” state may be determined on the basis of not the position information of the operation object but only the position information of the target object and the haptic presentation may be controlled.

Further, assumption is made that a target object can be released by performing an arbitrary command (operation) such as pushing a button by a user. In this case, the haptic presentation to the user is stopped at the timing when the target object was released. That is, when transitioning to the “release” state, the state may transition to the “release” state on the basis of not only target object information and object information but also information regarding a user's operation.

Further, the intensity of haptic sensation feedback at the time of release may be changed depending on the physical parameter of a target object. For example, in the case where a target object is set to an adhesive material or a material that can fall off, a strong haptic sensation may be presented first when releasing the target object and the haptic presentation to the user may be stopped when the target object and the operation object are away from each other by a certain distance or more. As a result, it is possible to present, to a user, an adhesive sensation like sticking when the adhesive target object is detached.

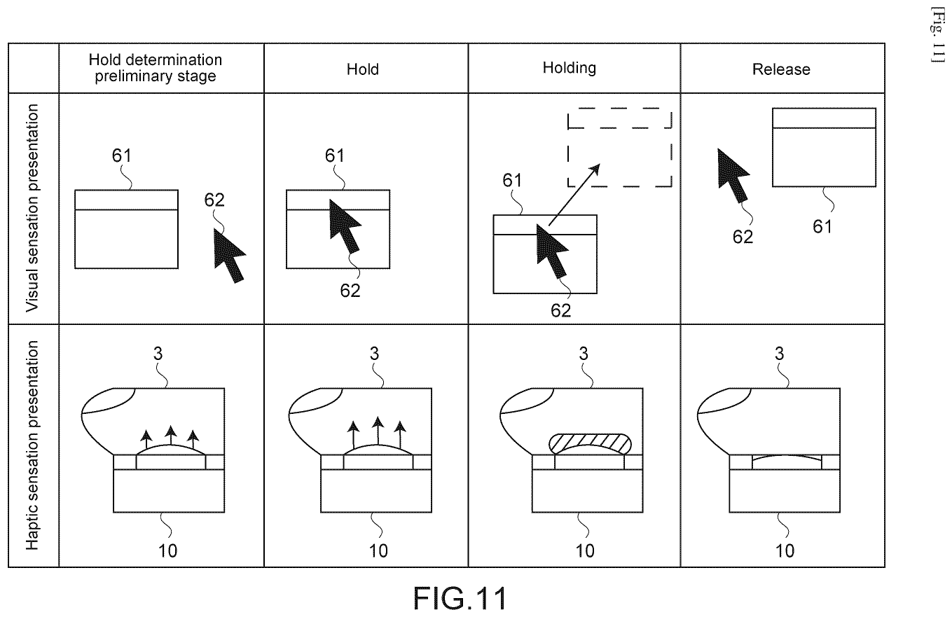

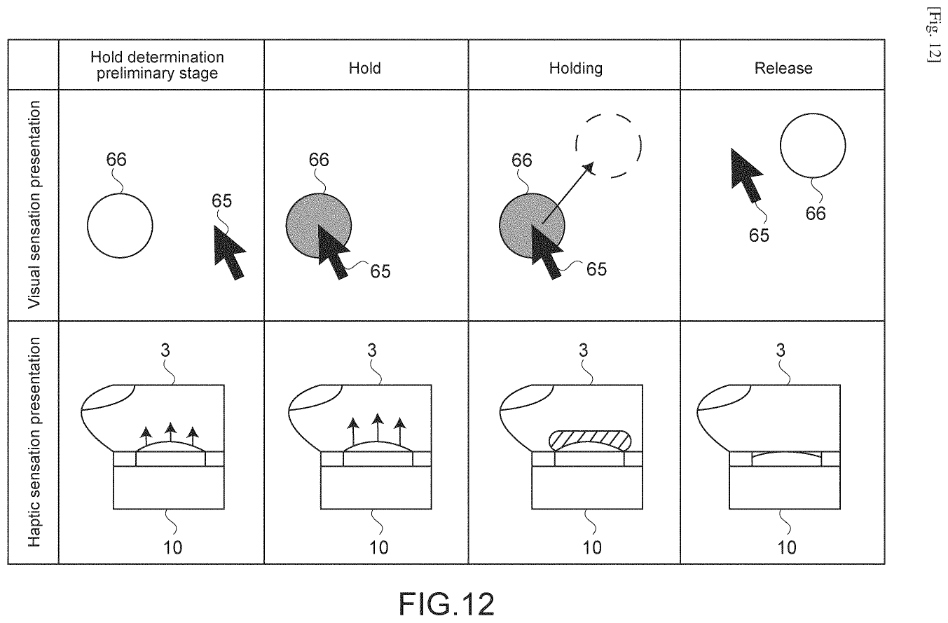

FIG. 11 and FIG. 12 are each a diagram showing an Example in which the operation object is not a hand.

In FIG. 11 and FIG. 12, an operation object 62 includes a cursor and a pointer. For example, the user 3 performs various operations such as movement of the operation object 62 and drag and drop via a mouse or a controller. An example of haptic presentation in each of the hold determination preliminary stage, hold, holding, and release states will be described with these operations of the operation object 60 as the specific action.

That is, the hold determination preliminary stage in the examples of FIG. 11 and FIG. 12 represents the state in which an operation object such as a cursor has approached a target object 61 such as a window within a predetermined distance.

Further, the hold represents the state of the moment when the user 3 performed the first operation of drag and drop performed for moving a window or the like, i.e., the moment of clicking the window. In addition, it goes without saying that in the case where the specific action is performed by various operations such as pressing a keyboard such as a shortcut key and double tap, the state of the moment when the operation was performed corresponds to the hold.

Further, the holding represents the state in which a window 61 follows in accordance with the movement of the cursor 62. Typical examples thereof include a state in which the user 3 holds the cursor over the window and holds down the button of the mouse. The present technology is not limited thereto, and in the case where the window can be held by holding the cursor over the window and clicking once, a haptic sensation may be presented even in the state in which the button of the mouse is not held down.

Further, the release represents the state in which the cursor 62 does not hold the window 61. Typically, the release represents that the user stops keeping the button of the mouse pressed.

As shown in FIG. 11, the information processing unit 22 determines the hold determination preliminary stage when the cursor 62 has approached the window 61 within a predetermined distance. A haptic sensation is presented to a user by outputting the haptic sensation data generating by the haptic sensation data generation unit 23 to the haptic sensation feedback device 10 such as a mouse. Similarly, a haptic sensation is presented to a user in accordance with each stage of the hold, holding, and release.

Note that in addition to the drag and drop of a window, in the case of dragging and dropping a file in a folder, a single haptic sensation regarding whether or not the file can be appropriately dropped in the file may be presented at the time of the release.

Further, in the case where the haptic sensation feedback device 10 is not installed in a mouse or the like or a haptic sensation cannot be presented to a finger by using a device such as a mouse, a haptic sensation feedback device capable of presenting a haptic sensation may be worn by a body portion of the user other than the finger.

FIG. 12 shows an example of haptic presentation in the operation regarding computer-aided design (CAD). For example, in FIG. 12, an assembly, a part, or the like is held as a target object 66 by an operation object 65.

For example, as shown in FIG. 12, when the operation object 65 approaches the target object 66, the hold determination preliminary stage is determined. Further, when the operation object 65 clicks and drags the target object 66, the hold and holding are determined, respectively.

Further, a haptic sensation may be presented when the part 66 during the holding has come into contact with another part. As a result, by presenting haptic sensation feedback when the part has come into contact with another part during the holding, contact information of parts regarding whether or not they can be incorporated may be clearly perceived.

Further, for example, in order to clarify the hold and holding, the target object 66 may be highlighted. Further, in the case of an assembly, a plurality of parts may be highlighted. Further, in the hold determination preliminary stage, a target object may be highlighted with a color different from those in the hold and holding.

Further, for example, the intensity of a haptic sensation to be presented may be changed in accordance with the number of parts being held.

Note that the determination of each state of the hold determination preliminary stage, hold, holding, and release and the presentation of a haptic sensation in each state are performed similarly to those in FIG. 1 to FIG. 11 described above.

As described above, in the information processing apparatus 20 according to this embodiment, the hold that is the state of the moment when the operation object 1 held the target object 2, the holding that is the state in which the operation object 1 continues to hold the target object 2, and the bold determination preliminary stage that is the state before entering the hold are determined on the basis of object information including position information of the operation object 1 and target object information including position information of the target object 2 and haptic sensation feedback is presented to the user 3 who operates the operation object 1 on the basis of the result of the determination. As a result, it is possible to improve usability.

In the past, there has been a haptic sensation device that is worn by two or more fingers and holds a virtual object. However, the configuration is complicated and the cost increases. Therefore, there is a device that cannot perform haptic presentation to only one finger in accordance with the intended use. Meanwhile, in the case of one finger, there is a problem that it is difficult to clearly indicate the state such as the hold of a virtual object and the release. For example, it is not clear whether it is the hold or the release in the case of a haptic sensation with only vibration or a virtual object is forcibly held when the finger approaches the virtual object.

In the present technology, the hold determination preliminary stage, i.e., the state on the way to transition to the hold, is clearly indicated to a user by haptic presentation. As a result, it is possible to easily hold a virtual object. Further, since haptic sensation feedback is presented to the tip of a finger, it only needs to prepare a compact and lightweight device including a system that acquires and generates target object information and object information to be used for determining each state of the hold determination preliminary stage, hold, holding, and release.

### Other Embodiments

The present technology is not limited to the embodiment described above, and various other embodiments can be realized.

In the embodiment described above, a virtual object present on a virtual space such as AR and VR has been used as a target object. The present technology is not limited thereto and is applicable even in the case where a real object is used as a target object and a robot arm is used as an operation object. In this case, a haptic sensation is presented from a haptic sensation feedback device mounted on a controller that operates the robot arm. It goes without saying that a haptic sensation feedback device may be worn by a body of a user instead of the controller.

For example, assumption is made that a user remotely operates a robot arm and checks the state of a factory including the robot arm via video. In this case, by presenting a haptic sensation when the robot arm holds and object, each of the hold determination preliminary stage, hold, holding, and release states may be perceived by a user. Although various haptic sensations may be presented to a user in accordance with the complicated movement of a robot arm, a simple configuration in which at least only a haptic sensation is presented to a user may be adopted.

Further, a robot arm or a target object being held collides with another target object during the holding, a haptic sensation stronger than the haptic sensation being presented or a different haptic sensation may be presented. Further, the hardness of a target object may be recognized by a user using the intensity of a haptic sensation to be presented.

Further, a control signal for performing image recognition for the type of a target object and moving a robot arm to the defined target point to automatically release the target object may be transmitted.

As a result, a user can perceive that the robot arm has failed to hold the target object, because no haptic sensation is presented. Further, since haptic presentation is stopped when the target object is released, the user can grasp that the robot arm is in a state of holding nothing.

In the embodiment described above, an operation object (hand) operated by a user has held a target object. The present technology is not limited thereto, and the user may operate a character of an application such as a game and a haptic sensation may be presented when the character has held a target object. For example, a haptic sensation is presented while the character holds the target object (holding) and the presentation of the haptic sensation is stopped when the character has released the target object (release).

Further, for example, a haptic sensation may be presented such that the weight or the difference in the center of gravity of a target object such as a sword and an ax can be understood. Further, a haptic sensation may be presented such that the difference in the strength of inertial force when shaking a target object can be understood. Further, in addition to a target object, a haptic sensation may be presented even when touching another character. That is, the hold determination preliminary stage may be determined when approaching within a predetermined range (invisible wall) with reference to another character, the hold may be determined when coming into contact with another character, and a haptic sensation may be presented.

In the embodiment described above, one target object has been held. The present technology is not limited thereto, and a plurality of target objects may be held. In this case, a haptic sensation may be presented on the basis of the number of target objects, the total weight, or the like.

In the embodiment described above, a pressure sensation has been mainly used as an example of a haptic sensation to be presented to a user. The present technology is not limited thereto, and each of the hold determination preliminary stage, hold, holding, and release states may be clearly indicated to a user by a haptic sensation such as a temperature change. For example, assumption is made that a target object is set to have a fever as a physical parameter. In this case, in the hold determination preliminary stage, a first temperature is presented. Further, in the hold, a second temperature higher than the first temperature is presented. Further, in the holding, a third temperature that increases in accordance with the time period of the holding is presented. Further, in the release, a fourth temperature that decreases from the third temperature as time passes from the moment when it was released.

The respective configurations of the information processing unit, the haptic sensation data generation unit, the haptic sensation data processing unit, and the like, as well as a control flow performed by the communication system described with reference to the drawings are merely embodiments, and modifications can be arbitrarily made without departing from the essence of the present technology. That is, other arbitrary configurations, algorithms, and the like for implementing the present technology may be adopted.

Note that the effects described herein are merely illustrative and not restrictive, and may have other effects. The above description of the plurality of effects does not nec-essarily mean that these effects are simultaneously exhibited. It means that at least one of the effects described above can be achieved and there is a possibility that an effect that is not described in the present disclosure is exhibited.

Of the feature portions of each embodiment described above, at least two feature portions can be combined. That is, the various feature portions described in the respective embodiments may be arbitrarily combined irrespective of the embodiments.

It should be noted that the present technology may take the following configurations.
(1)

An information processing method comprising:
determining a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determining distances between the operation object and the target object in the virtual space in the third state, the determined distances including a first distance and a second distance which is less than the first distance;
transitioning from the third state to the first state in response to determining the second distance;
transitioning from the first state to the second state; and
generating haptic sensation signals corresponding to each of the first state, the second state, and the third state.
(2)

The method of (1), further comprising:
transitioning from the second state to the fourth state; and
generating a haptic sensation signal corresponding to the fourth state.
(3)

The method of(1) or (2), wherein haptic sensations change at each transition between states.
(4)

The method of (1) to (3), wherein the operation object is a finger, a hand or a glove.
(5)

The method of (1) to (4), wherein the first action of the first state is touching the target object.
(6)

The method of (1) to (5), wherein the operating object bolds the target object during the second state.
(7)

The method of (1) to (6), wherein the operating object approaches the target object in the third state.
(8)

The method of (2) to (7), wherein the operating object releases the target object at the fourth state.
(9)

The method of (1) to (8), wherein the third state is entered when the operation object is at a third distance which is a threshold, the third distance being equal or greater than the first distance.
(10)

The method of (1) to (9), wherein the second distance is zero or negative.
(11)

The method of (2) to (10), wherein at least one of the third state or the fourth state is triggered by a gesture.
(12)

The method of (11), wherein the gesture includes a finger bending.
(13)

The method of (1) to (12), wherein the first distance varies based on a size of the target object.
(14)

The method of (1) to (13), wherein a weight of the target object corresponds to a magnitude or an amount of a haptic sensation of the second state.
(15)

The method of (1) to (14), further comprising, when the operation object takes the first action on the target object, adding to at least one of the target object or the operation object an effect of at least one of light emission, blinking, and a color change.
(16)

The method of (1) to (15), further comprising presenting haptic sensations of the operation object and second haptic sensations of a second operation object in opposite directions.
(17)

The method of (1 to 16), wherein the target object represents a real object, and the virtual space is presented to a user controlling a robot in a real space which includes the real object.
(18)

The method of (1) to (17), wherein haptic sensations caused by the haptic sensation signals include a pressure and at least one of a vibration or a temperature change.
(19)

The method of (1) to (18), wherein the operation object takes a second action, which is a different type of action than the first action.
(20)

The method of (1) to (18), wherein the operation object takes a second action, which is repeating the first action again.
(21)

An information processing apparatus comprising:
at least one processor configured to:
determine a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determine distances between the operation object and the target object in the virtual space in the third state, the determined distances including a first distance and a second distance which is less than the first distance;
transition from the third state to the first state in response to determining the second distance;
transition from the first state to the second state; and
generate haptic sensation signal corresponding to each of the first state, the second state, and the third state.
(22)

A system comprising:
the information processing apparatus of (21);
a tracking device configured to track movement of a user;
a video display configured to display the target object and the operation object in the virtual space; and
a haptic device to present the haptic sensations based on the haptic sensation signal for each of the plurality of states.
(23)

The system of (22), further comprising a glove, which includes the tracking device and the haptic device, and a head-mounted display which includes the video display.
(24)

A program stored on a computer readable medium, which when executed by a processor, causes the processor to:
determine a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determine distances between the operation object and the target object in the virtual space in the third state, the determined distances including a first distance and a second distance which is less than the first distance;
transition from the third state to the first state in response to determining the second distance;
transition from the first state to the second state; and
generate haptic sensation signal corresponding to each of the first state, the second state, and the third state.
(25)

An information processing apparatus, including:
a determination unit that determines, on a basis of object information including information regarding a position of an operation object and target object information including information regarding a position of a target object, a first state, a second state, and a third state, the first state being a state of a moment when the operation object took a specific action on the target object, the second state being a state in which the operation object continues the specific action on the target object, the third state being a state before transitioning to the first state; and
a presentation unit that presents, on a basis of a result of the determination, haptic sensation feedback to a user who operates the operation object.
(26)

The information processing apparatus according to (25), in which
the specific action includes an action in which the operation object holds the target object.
(27)

The information processing apparatus according to (25) or (26), in which
the determination unit determines, on a basis of a distance with reference to the target object, one of the first state, the second state, and the third state.
(28)

The information processing apparatus according to (25) to (27), in which
the determination unit determines the third state, where a distance between the operation object and the target object is between a first threshold value and a second threshold value larger than the first threshold value, and determines the first state, where the distance between the target object and the operation object is smaller than the first threshold value.
(29)

The information processing apparatus according to (25) to (28), in which
the determination unit determines the second state, where the distance between the operation object and the target object decreases after the first state is determined.
(30)

The information processing apparatus according to (25) to (29), in which
the haptic sensation feedback of the presentation unit is stronger as the distance between the target object and the operation object decreases.
(31)

The information processing apparatus according to (25) to (30), in which
the object information includes action information regarding an action of the operation object, and
the determination unit determines the third state, where the action of the action information is performed in a region with reference to the target object.
(32)

The information processing apparatus according to (25) to (31), in which
the determination unit determines the first state, where speed of the operation object is a threshold value or more and the operation object is in contact with the target object.
(33)

The information processing apparatus according to (25) to (32), in which
the target object information includes a physical parameter relating to the target object, and
the physical parameter includes at least one of a size of the target object, a shape of the target object, weight of the target object, hardness of the target object, viscosity of the target object, a position of a centroid of the target object, or a temperature of the target object.
(34)

The information processing apparatus according to (33), in which
the determination unit determines, on a basis of speed of the operation object and the physical parameter, a fourth state in which the operation object does not take the specific action on the target object.
(35)

The information processing apparatus according to (33) or (34), in which
the presentation unit presents the haptic sensation feedback on a basis of the physical parameter.
(36)

The information processing apparatus according to (25) to (35), in which
the haptic sensation feedback of the presentation unit is stronger as the weight of the target object increases.
(37)

The information processing apparatus according to (25) to (36), in which
the haptic sensation feedback of the presentation unit is stronger as the size of the target object increases.
(38)

The information processing apparatus according to (25) to (37), in which
the haptic sensation feedback of the presentation unit is stronger in the second state and where the target object is in contact with another object.
(39)

The information processing apparatus according to (25) to (38), in which
the haptic sensation feedback includes at least one of a pressure, vibration, sound, a temperature, or light.
(40)

The information processing apparatus according to (25) to (39), in which
the haptic sensation feedback of the presentation unit is momentarily stronger when transitioning from the third state to the first state.
(41)

The information processing apparatus according to (33) to (40), in which
the haptic sensation feedback of the presentation unit is stronger on a basis of the physical parameter in the second state and where the operation object moves.
(42)

The information processing apparatus according to (25) to (41), in which
the presentation unit controls the haptic sensation feedback on a basis of a movement direction of the operation object in the second state and where the operation object moves.
(43)

An information processing method executed by a computer system, including:
determining, on a basis of object information including information regarding a position of an operation object and target object information including information regarding a position of a target object, a first state, a second state, and a third state, the first state being a state of a moment when the operation object took a specific action on the target object, the second state being a state in which the operation object continues the specific action on the target object, the third state being a state before transitioning to the first state; and
presenting, on a basis of a result of the determination, haptic sensation feedback to a user who operates the operation object.
(44)

A program that causes a computer system to execute the steps of:
determining, on a basis of object information including information regarding a position of an operation object and target object information including information regarding a position of a target object, a first state, a second state, and a third state, the first state being a state of a moment when the operation object took a specific action on the target object, the second state being a state in which the operation object continues the specific action on the target object, the third state being a state before transitioning to the first state; and
presenting, on a basis of a result of the determination, haptic sensation feedback to a user who operates the operation object.

It should be understood by those skilled in the art that various modifications, com-binations, sub-combinations and alterations may occur depending on design requirements and other factors insofar as they are within the scope of the appended claims or the equivalents thereof.

### REFERENCE SIGNS LIST

1 operation object
2 object
3 user
10 haptic sensation feedback device
20 information processing apparatus
22 information processing unit
23 haptic sensation data generation unit
24 haptic sensation data processing unit

1. An information processing method comprising:
determining a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determining distances between the operation object and the target object in the virtual space in the third state, the determined distances including a first distance and a second distance which is less than the first distance;
transitioning from the third state to the first state in response to determining the second distance;
transitioning from the first state to the second state; and
generating haptic sensation signals corresponding to each of the first state, the second state, and the third state.

2. The method of claim 1, further comprising:
transitioning from the second state to the fourth state; and
generating a haptic sensation signal corresponding to the fourth state.

3. The method of claim 1, wherein haptic sensations change at each transition between states.

4. The method of claim 1, wherein the operation object is a finger, a hand or a glove.

5. The method of claim 1, wherein the first action of the first state is touching the target object.

6. The method of claim 1, wherein the operating object holds the target object during the second state.

7. The method of claim 1, wherein the operating object approaches the target object in the third state.

8. The method of claim 2, wherein the operating object releases the target object at the fourth state.

9. The method of claim 1, wherein the third state is entered when the operation object is at a third distance which is a threshold, the third distance being equal or greater than the first distance.

10. The method of claim 1, wherein the second distance is zero or negative.

11. The method of claim 2, wherein at least one of the third state or the fourth state is triggered by a gesture.

12. The method of claim 11, wherein the gesture includes a finger bending.

13. The method of claim 1, wherein the first distance varies based on a size of the target object.

14. The method of claim 1, wherein a weight of the target object corresponds to a magnitude or an amount of a haptic sensation of the second state.

15. The method of claim 1, further comprising, when the operation object takes the first action on the target object, adding to at least one of the target object or the operation object an effect of at least one of light emission, blinking, and a color change.

16. The method of claim 1, further comprising presenting haptic sensations of the operation object and second haptic sensations of a second operation object in opposite directions.

17. The method of claim 1, wherein the target object represents a real object, and the virtual space is presented to a user controlling a robot in a real space which includes the real object.

18. The method of claim 1, wherein haptic sensations caused by the haptic sensation signals include a pressure and at least one of a vibration or a temperature change.

19. The method of claim 1, wherein the operation object takes a second action, which is a different type of action than the first action.

20. The method of claim 1, wherein the operation object takes a second action, which is repeating the first action again.

21. An information processing apparatus comprising:
at least one processor configured to:
determine a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determine distances between the operation object and the target object in the virtual space in the third state, the determined distances including a first distance and a second distance which is less than the first distance;
transition from the third state to the first state in response to determining the second distance;
transition from the first state to the second state; and
generate haptic sensation signals corresponding to each of the first state, the second state, and the third state.

22. A system comprising:
the information processing apparatus of claim 21;
a tracking device configured to track movement of a user;
a video display configured to display the target object and the operation object in the virtual space; and
a haptic device to present the haptic sensations based on the haptic sensation signal for each of the plurality of states.

23. The system of claim 22, further comprising a glove, which includes the tracking device and the haptic device, and a head-mounted display which includes the video display.

24. A program stored on a computer readable medium, which when executed by a processor, causes the processor to:
determine a plurality of states of an operation object in relation to a target object in a virtual space, the states including a first state in which the operation object takes a first action on the target object, a second state in which the operating object maintains the first action on the target object, the second state occurring after the first state, and a third state prior to the first state;
determine distances between the operation object and the target object in the virtual space in the third state, the determined distances including a first distance and a second distance which is less than the first distance;
transition from the third state to the first state in response to determining the second distance;
transition from the first state to the second state; and
generate haptic sensation signals corresponding to each of the first state, the second state, and the third state.
